(19) United States
(12) Patent Application Publication
(10) Pub. No.: US 2026/0259860 A1
(43) Pub. Date: Sep. 3, 2026

(54) Use of Generative Artificial Intelligence to Create Source to Target Mappings and Transformations

(71) Applicant: Ab Initio Technology LLC, Lexington, MA (US)

(72) Inventors: Stephen Brobst, Orlando, FL (US); Ian Schechter, Sharon, MA (US); Arun Kavishwar, Lexington, MA (US)

(21) Appl. No.: 19/552,943

(22) Filed: Feb. 27, 2026

Related U.S. Application Data
(60) Provisional application No. 63/765,271, filed on Feb. 28, 2025.

(51) Int. Cl. G06F 16/21; G06N 20/00

(52) U.S. Cl. CPC G06F 16/211; G06N 20/00

(57) ABSTRACT

A method for using a machine learning model to identify mappings and transformations to map and transform datasets from a first schema to a second schema, including: receiving an indication of datasets, with the datasets being structured with portion of the datasets; based on the profiled data and metadata associated with the datasets, identifying classifications for fields; generating classification associations among the identifiers and the classifications; receiving a second schema to which the datasets are to be transformed; inputting, into a machine learning model, the profiled data, the classification associations and the second schema; and receiving, from the machine learning model, an output specifying mappings and transformations to be performed on the datasets to map and transform the datasets from being in accordance with the first schema to being in accordance with the second schema.

### CROSS-REFERENCE TO RELATED APPLICATIONS

This application claims priority under 35 U.S.C. § 119(e) to U.S. Provisional Patent Application No. 63/765,271, filed on February 28, 2025, the entire contents of which are hereby incorporated by reference.

### TECHNICAL FIELD

The present specification relates to methods performed by a computer system, computer systems and computer-readable media for automatically identifying mappings and transformations needed to transform data from a source schema into a target schema and generating a specification with those mappings and transformations.

### BACKGROUND

Modern data processing systems manage vast amounts of data within an enterprise. A large institution, for example, may have millions of datasets. These datasets can support multiple aspects of the operation of the enterprise.

### SUMMARY

Data is often mapped and transformed from a source system to a target system. A source system is associated with a source schema and a collection of source value domains. A target system is associated with a target schema and a collection of target value domains. Data in a source system or associated with a source system is referred to as source data. Data in a target system or associated with a target system is referred to as target data. Source data conforms with the source schema and the collection of source value domains. For example, source data has a structure that conforms with (e.g., is in accordance with) a source schema and has values that conform with the collection of source value domains. Target data conforms with the target schema and the collection of target value domains. For example, target data has a structure that conforms with the target schema and has values that conform with the target value domains.

In order for the source data to be successfully mapped and transformed to the target system, a process needs to occur to identify the mappings and transformations. This process often identifies extensive mappings and transformations. Generally, a mapping indicates an association among one or more fields specified by the source schema and one or more fields specified by the target schema. For example, a mapping can indicate an association between a field specified by the source schema and a field specified by the target schema, among a field specified by the source schema and many fields specified by the target schema, among many fields specified by the source schema and a field specified by the target schema, among many fields specified by the source schema and many fields specified by the target schema, and so forth. That is, a mapping could be one-to-one, one-to-many, many-to-one, many-to-many, and so forth. Generally, a transformation indicates one or more operations that need to be performed on source data to produce target data (e.g., conforming with the target value domains and the target schema).

To further complicate matters, a source system often has a source schema, and each source schema may include hundreds or thousands of different source datasets. Each dataset may include hundreds or thousands of data elements, and those hundreds or thousands of data elements may have their values drawn from the source value domains. These hundreds or thousands of data elements in these source datasets in the source schema need to be mapped and transformed from “source to target,” e.g., transforming the source data from conforming with the source schema and the source value domains to conforming with the target schema and the target value domains. One practice for identifying these mappings and transformations is usuallyby primarily manual techniques, in which individuals analyze and study the source system (and all the hundreds or thousands of source datasets in the source schema and collections of source value domains) and the target system to identify the needed mappings and transformations. This is an incredibly time intensive and inefficient process, and results in delays in source data being transformed into target data. The process is also error prone, as an individual is relying on his/her judgement and can easily incorrectly identify a mapping or a transformation, especially when these mappings and transformations have to be identified for hundreds or thousands of data elements of different source datasets from different source schemas and collections of source value domains.

The techniques described herein overcome many of these deficiencies by providing an integrated method embodied in computer software for use with a computer for rapid, efficient identification of mappings and transformations, thereby allowing source data to be mapped and transformed from a source system to a target system in a very efficient, accurate manner.

To identify these mappings and transformations quickly, efficiently and in an automated manner, the system described herein generates a transformation vocabulary that associates names with known transformations (or known sequences of transformations). The system also identifies mappings for inputs and outputs of these transformations. Using this transformation vocabulary and the identified mappings, the system generates a description of inputs and outputs associated with the named transformations in the transformation vocabulary. Then, the system trains a machine learning model on these descriptions to enable the machine learning model to quickly and efficiently identify mappings and transformations for source data. When the system receives source data (e.g., new source data), the system profiles the source data and performs semantic discovery on the source data to generate a knowledge graph. Having already been trained on the descriptions, the machine learning model can then use this profiled data and the knowledge graph to identify mappings and transformations to transform the source data from source to target.

As such, the techniques described herein allow computers to efficiently, automatically and accurately identify mappings and transformations. In particular, these techniques use a combined order of specific operations to generate a transformation vocabulary and descriptions, and to train the machine learning model on these descriptions. The machine learning model is then used and applied to create desired results: sequences of mappings and transformations. Additionally, using these techniques, it is possible to create new combinations of mappings and transformations that have not previously been identified.

In general, in a first aspect, a computer-implemented method for using a machine learning model to automatically identify mappings and transformations to map and transform datasets from a first schema to a second schema, includes: receiving one or more indications of one or more datasets, with the one or more datasets being structured with one or more fields, and with a first schema specifying one or more identifiers for the one or more fields; responsive to the one or more indications, accessing the one or more datasets and metadata associated with the one or more datasets; profiling at least a portion of the one or more datasets accessed to generate profiled data; based on the profiled data and the metadata, identifying one or more classifications for the one or more fields; generating one or more classification associations among the one or more identifiers and the one or more classifications, wherein a given identifier of the one or more identifiers is associated with a given classification of the one or more classifications, wherein the given identifier is associated with a given field of the one or more fields, and wherein the given classification classifies the given field associated with the given identifier; receiving a second schema to which the datasets are to be transformed; inputting, into a machine learning model, the profiled data, the classification associations and the second schema; and receiving, from the machine learning model, an output specifying one or more mappings and one or more transformations to be performed on the one or more datasets to map and transform the one or more datasets from being in accordance with the first schema to being in accordance with the second schema.

In general, in a second aspect combinable with the first aspect, at least one of the one or more mappings is among the one or more identifiers and one or more second identifiers specified by the second schema.

In general, in a third aspect combinable with the first or second aspects, receiving the output includes receiving an output specifying one or more mappings and one or more transformations to be performed on the one or more datasets to transform the one or more datasets from being in accordance with the first schema and one or more first domain values to being in accordance with the second schema and one or more second domain values.

In general, in a fourth aspect combinable with any of the first through third aspects, the first schema is a source schema, and the second schema is a target schema.

In general, in a fifth aspect combinable with any of the first through fourth aspects, the profiling includes profiling one or more fields of the one or more datasets.

In general, in a sixth aspect combinable with any of the first through fifth aspects, the output is a specification.

In general, in a seventh aspect combinable with any of the first through sixth aspects, the method further includes transforming the output into a computational dataflow graph for processing one or more data records of the one or more datasets.

In general, in an eighth aspect combinable with any of the first through seventh aspects, the method further includes performing training of the machine learning model, by: accessing, from a data store, a plurality of specifications; identifying a plurality of transformations specified by the specifications; generating a vocabulary of transformations, by: for each transformation, naming the transformation; for a given transformation, identifying one or more mappings for one or more inputs and one or more outputs of the given transformation; based on the generated vocabulary and identified mappings, generating descriptions of inputs and outputs associated with named transformations in the transformation vocabulary, with a description describing how data is mapped and transformed from a source schema and source value domain to a target schema and target value domain; transmitting, to a machine learning model trainer, the generated descriptions; and training, by the machine learning model trainer, the machine learning model on the generated descriptions.

In general, in a ninth aspect, a computer-implemented method for training a machine learning model to automatically identify mappings and transformations for mapping and transforming datasets from one schema to another schema includes: accessing, from a data store, a plurality of specifications, with a specification specifying a transformation, an input to the transformation and an output from the transformation; for a given specification, generating a mapping between an input to a transformation and an output from the transformation; associating a name with the transformation; and generating a description of the transformation, with the description specifying the name and the mapping; transmitting, to a machine learning model trainer, generated descriptions of transformations; and causing training, by the machine learning model trainer, of a machine learning model based on the generated descriptions to train the machine learning model to automatically identify one or more mappings among one or more inputs and one or more outputs and one or more names of transformations for transforming the one or more inputs into the one or more outputs.

In a tenth aspect combinable with the ninth aspect, the mappings included in the generated descriptions represent mappings of first fields in a first schema to second fields in a second schema, and wherein a name specifies one or more transformations to be performed in transforming a value of a first field into a value for a second field.

In an eleventh aspect combinable with the ninth or tenth aspects, the one or more inputs are based on one or more fields of a first schema, and wherein the one or more outputs are based on one or more fields of a second schema.

In a twelfth aspect combinable with any of the ninth through eleventh aspects, the method further includes for a given specification, augmenting the description of the transformation with metadata for the input to the transformation and the output from the transformation.

In general, in a thirteenth aspect, one or more machine-readable hardware storage devices, such as one or more non-transitory machine-readable hardware storage devices, store instructions that are executable by one or more processing devices to perform operations of any of the first through twelfth aspects.

In general, in a fourteenth aspect, a data processing system includes one or more processing devices, and one or more machine-readable hardware storage devices storing instructions that are executable by the one or more processing devices to perform operations of any of the first through twelfth aspects.

In general, in a fifteenth aspect, an apparatus includes one or more processing devices, and one or more machine-readable hardware storage devices storing instructions that are executable by the one or more processing devices to perform operations of any of the first through twelfth aspects.

Implementations of one or more of the above aspects can provide one or more of the following advantages.

In some examples, the described techniques can improve data quality and data integrity (e.g., accuracy, consistency, completeness, and reliability of data) by avoiding (or reducing) erroneous transformations from the source to the target. Additionally, because the techniques described herein understand the semantic meaning of the underlying data, these techniques could be able to identify more accurate mappings and transformations to the target schema.

Generating augmented transformation descriptions provides a technical improvement to the training and functional utility of machine learning models. By enriching raw transformation logic with contextual metadata retrieved from a metadata store, a system provides a trainer with highly structured logic that serves as enriched training data for a machine learning model. This data augmentation enables a generation agent to learn underlying business logic and categorical constraints, such as domain-specific groupings, rather than merely identifying syntactic patterns within a transformation. This specific adaptation of the training data allows a machine learning model to establish a high-dimensional representation of schema relationships, which enhances the ability of the model to generalize across new, unseen source schemas. Consequently, the machine learning model can more reliably identify correct mappings by resolving semantic ambiguities that are not present in raw code or basic spreadsheets, thereby ensuring a more consistent technical state when transforming data between disparate systems.

The integration of a validation agent provides a closed-loop system that optimizes computational resource allocation. By performing static validation and automated testing before final code storage, the system ensures that only valid, executable instructions are persisted in the code store. This prevents the execution of faulty dataflow graphs that would otherwise consume significant CPU and memory resources during high-volume ingestion. Furthermore, the iterative feedback loops back to the generation agent allow the system to self-correct and refine mapping logic without requiring manual code intervention, thereby maintaining high system availability.

A further technical advantage is the improvement in data security during the mapping identification process. Because the generation agent is provided with a summary of content and a knowledge graph, rather than raw data records, the system can identify transformations without exposing personally identifiable information (PII) to the machine learning model. This allows for the automated generation of complex ETL logic while maintaining a minimized data footprint, thereby reducing the attack surface for potential data breaches.

The use of a transformation vocabulary and standardized augmented descriptions ensures technical consistency across diverse ingestion use cases. This uniformity can improve root cause analysis and error traceability. For example, because the generation agent produces consistent logic patterns, the system can more efficiently identify systemic errors across multiple data pipelines, leading to a more stable and predictable data processing environment.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A, 2B, 4A-4C and 4E each illustrates an example system for identification of source to target mappings and transformations.

FIG. 1B illustrates an example environment for validation.

FIGS. 2A and 3 each illustrates an example environment for generating transformation descriptions.

FIG. 4D illustrates an example environment for a machine learning (ML) model to receive feedback on a proposed transformation.

FIG. 5 is a flow diagram of an example process for using a machine learning model to automatically identify mappings and transformations to map and transform datasets from a first schema to a second schema.

FIG. 6 is a flow diagram of an example process for training a machine learning model to automatically identify mappings and transformations for mapping and transforming datasets from one schema to another schema.

FIG. 7 is a diagram illustrating an example computing system.

Like reference symbols in the various drawings indicate like elements.

### DETAILED DESCRIPTION

The system described herein uses and trains artificial intelligence (AI) models to create the mappings and transformations needed to transform source data in accordance with a target schema, e.g., to enable source data to be automatically ingested and stored in a target system (e.g., a data warehouse). Generally, ingestion is the process of collecting and moving data from various sources to a target for storage, processing, analysis, and so forth.

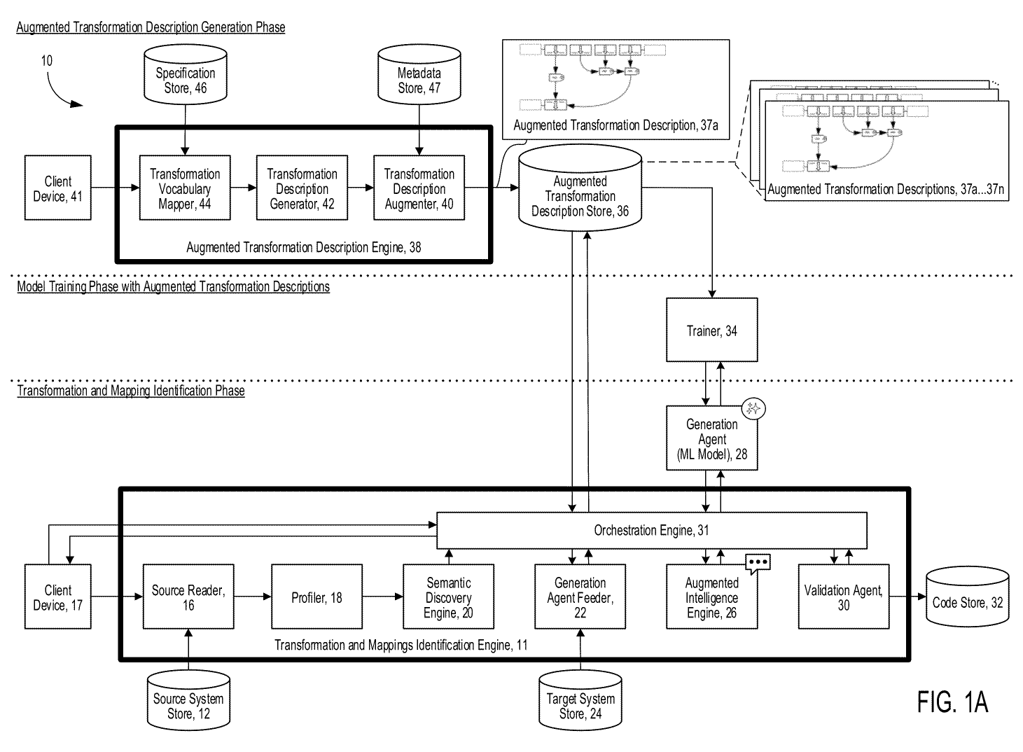

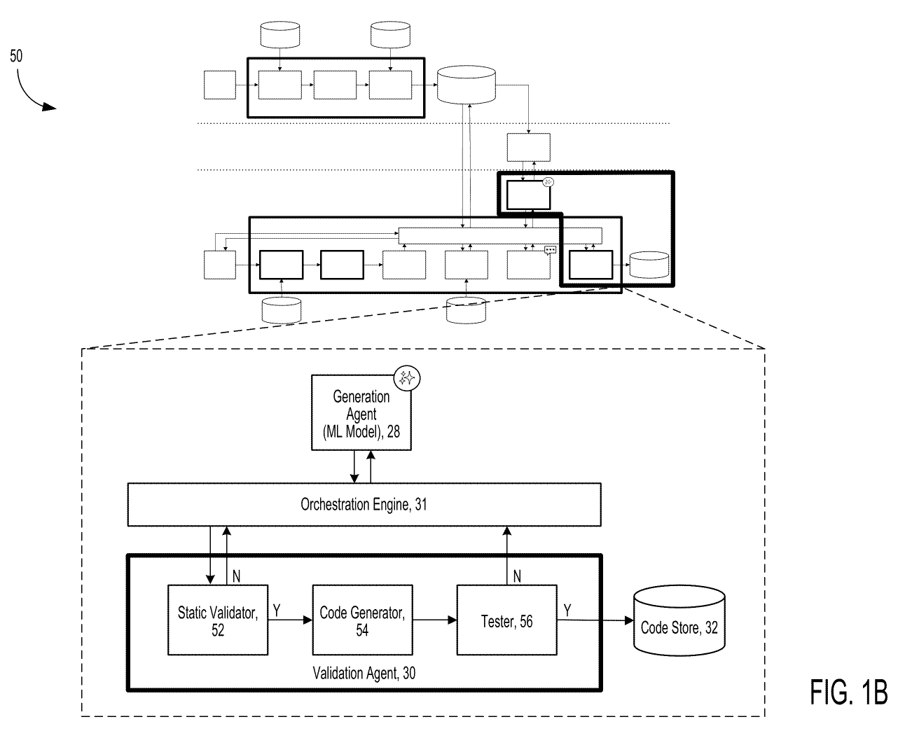

Referring to FIG. 1A, an environment 10 is shown for the generation of augmented transformation descriptions and the subsequent identification of source-to-target mappings and transformations. In this example, the environment 10 is organized into three functional phases, including an augmented transformation description generation phase, a model training phase, and a transformation and mapping identification phase.

In the description generation phase, an augmented transformation description engine 38 generates descriptions of transformation logic for transforming source data from a source schema to a target schema. Each of the descriptions can be written in a transformation language that includes one or more transformation vocabularies (e.g., a collection of transformation vocabularies). Generally, a transformation vocabulary includes names for describing transformations, indicators associated with particular transformations, and so forth. The augmented transformation description engine 38 includes a transformation vocabulary mapper 44 that receives specifications from a specification store 46 and maps names in a vocabulary to operations in the specifications. In general, a specification is a file or other data structure that includes data describing operations to be performed. Specifications can include instructions, computer code, or spreadsheets for specifying operations (e.g., transformations) for transforming data among different processing layers.

The augmented transformation description engine 38 also includes a transformation description generator 42 for generating descriptions (also referred to herein as transformation descriptions) to associate with the mappings generated by the transformation vocabulary mapper 44. A transformation description augmenter 40 is configured to augment the descriptions generated by the transformation description generator 42 with metadata to provide context. The transformation description augmenter 40 receives contextual metadata from a metadata store 47. The metadata store 47 can provide business context, standardized tags, or domain-specific definitions that enrich the transformation logic. The resulting enriched logic is stored as augmented transformation descriptions 37a...37n in an augmented transformation description store 36.

In the model training phase, a trainer 34 accesses the augmented transformation descriptions 37a...37n from the augmented transformation description store 36 to train a generation agent 28. The generation agent 28 may encompass a variety of machine learning (ML) models, including, e.g., regression, neural networks, and so forth. In this example, the generation agent 28 utilizes a ML model (e.g., a large language model (LLM), a generative AI model, and so forth) and is trained to output a specification with mappings and transformations based on an input prompt. This training process can involve reinforcement learning, supervised learning, semi-supervised learning, or unsupervised learning techniques. The augmented transformation descriptions 37a...37n serve as “ground truth” logic that enables the generation agent 28 to eventually work on raw, unmapped source data.

In the transformation and mapping identification phase, a transformation and mappings identification engine 11 identifies source-to-target mappings and transformations for mapping and transforming source data to a target schema. The environment 10 includes a source system store 12 that stores data (e.g., source data). Generally, source data (e.g., a source dataset) includes data that is accessible, e.g., to a process, a system, and so forth. Source data is in accordance with (e.g., conforming with) a source schema, a source value domain (and/or a collection of source value domains), and so forth. Generally, a schema includes a collection of tables with columns, a collection of datasets with data elements, and so forth. As such, a source schema includes a schema associated with a source system, source data, and so forth. Generally, a value domain includes a set of possible values for a field, a data source and so forth. Generally, a source value domain includes a value domain associated with a source system.

Environment 10 also includes a client device 17, such as a user device or an automated software process, for initiating a process of identifying transformations and mappings for transforming source data, which is in accordance with a source schema, to a target schema. Generally, a target schema includes a schema associated with a target system, target data (e.g., a target dataset), and so forth. Generally, target data includes data with one or more specified characteristics (e.g., structure, type, format, values and so forth). Target data is in accordance with (e.g., conforming with) a target schema, a target value domain (and/or a collection of target value domains), and so forth. Generally, a target value domain includes a value domain associated with a target system.

Transformation and mappings identification engine 11 also includes a source reader 16 for scanning the source system store 12 for source data (or otherwise accessing source data from source system store 12) upon initiation of the transformations and mappings identification process. A profiler 18 of the transformation and mappings identification engine 11 then profiles the source data, e.g., as described in U.S. Patent No. 8,868,580, titled “Data Profiling,” the entire contents of which are incorporated herein by reference.

The profiler 18 can profile data from a variety of types of systems including different forms of database systems. The data may be organized as records having values for respective fields (also called “attributes” or “columns”), including possibly null values. The profile information can be organized to provide separate profiles for different fields, called “field profiles” describing values that occur in those fields. When first reading data from a data source, profiler 18 typically starts with some initial format information about records in that data source. (Note that in some circumstances, even the record structure of the data source may not be known initially and may instead be determined after analysis of the data source). The initial information about records can include the number of bits that represent a distinct value, the order of fields within a record, and the type of value (e.g., string, signed/unsigned integer) represented by the bits. As the profiler 18 reads records from a data source, it computes statistics and other descriptive information that reflect the values in a given field. The profiler 18 then stores those statistics and descriptive information in the form of field profiles for access by the semantic discovery engine 20 (described below). The statistics in the field profile for a given field can include, for example, a histogram of values in that field, maximum, minimum, and mean values occurring in that field, and samples of the least common and most common values occurring in that field. The profile information can also include information associated with multiple fields of the records in source system 12 such as total number of records, and total number of valid or invalid records.

Transformation and mappings identification engine 11 also includes a semantic discovery engine 20 to perform semantic discovery, e.g., as described in U.S. Patent No. 11,704,494 (entitled “Discovering a Semantic Meaning of Data Fields from Profile Data of the Data Fields”) and U.S. Patent No. 11,886,399 (entitled “Generating Rules for Data Processing Values of Data Fields from Semantic Labels of the Data Fields”), the entire contents of each of which are incorporated herein by reference. In particular, the semantic discovery engine 20 is configured to determine a meaning (e.g., a semantic meaning) of values for one or more fields of data records. Generally, a semantic meaning of a field includes a description of the values of the field. The description may specify a practical (e.g., business) meaning of the values of the field. To identify a semantic meaning of fields, the semantic discovery engine 20 is configured to label fields (e.g., from source datasets) with a semantic label that is selected from a data dictionary database. Generally, a data dictionary database includes a database storing a data structure (e.g., a table) that specifies semantic labels and associated attributes of the semantic labels. The semantic label (also called a label) is associated with one or more attributes in the data dictionary database. The label may be a name, a term, an entry in a dictionary, and so forth. The attributes associated with the semantic label define a semantic meaning of the label, as described in further detail below.

An orchestration engine 31 coordinates the flow of information between components of the transformation and mappings identification engine 11, such as the semantic discovery engine 11 and a generation agent feeder 22, and the generation agent 28. For example, the orchestration engine 31 can receive, among other things, data output by the semantic discovery engine 20 and a target schema retrieved by the generation agent feeder 22 from a target system store 24, and can provide this data to the generation agent 28 along with suitable instructions (e.g., prompts) for identifying the source-to-target transformations and mappings. In some examples, the orchestration engine 31 also facilitates retrieval of relevant examples (e.g., candidates) from the augmented transformation description store 36 to assist the generation agent 28. Using this information, the generation agent 28 generates a specification describing the source-to-target transformations and mappings, as described herein.

Environment 10 also includes an augmented intelligence engine 26 for providing input to generation agent 28 and facilitating communication between the generation agent 28 and the client device 17 via the orchestration engine 31. For example, augmented intelligence engine 26 may obtain input on proposed outputs, mappings, transformations, and so forth from the client device 17, and provide this information to the generation agent 28. Environment 10 includes validation agent 30 for validating the accuracy and/or consistency of data output by generation agent 28. Environment 10 includes code store 32 for storing instructions (e.g., executable instructions, code and so forth).

Referring to FIG. 1B, environment 50 is shown for validating the output of the generation agent 28. In this example, the validation agent 30 includes a static validator 52 for performing static validation, including, e.g., validating that an output of the generation agent 28 complies with certain requirements, standards, criteria, and so forth. If the static validator 52 fails (indicated by the “N” path), feedback is sent back to the orchestration engine 31 to initiate a refinement loop with the generation agent 28. If validation passes (“Y”), a code generator 54 generates executable instructions (e.g., code) based on the output of the generation agent 28. A tester 56 runs and tests the executable instructions. If the test fails (“N”), feedback is sent to the orchestration engine 31. Once the tester 56 has successfully tested the executable instructions (“Y”), the finalized code is stored in a code store 32.

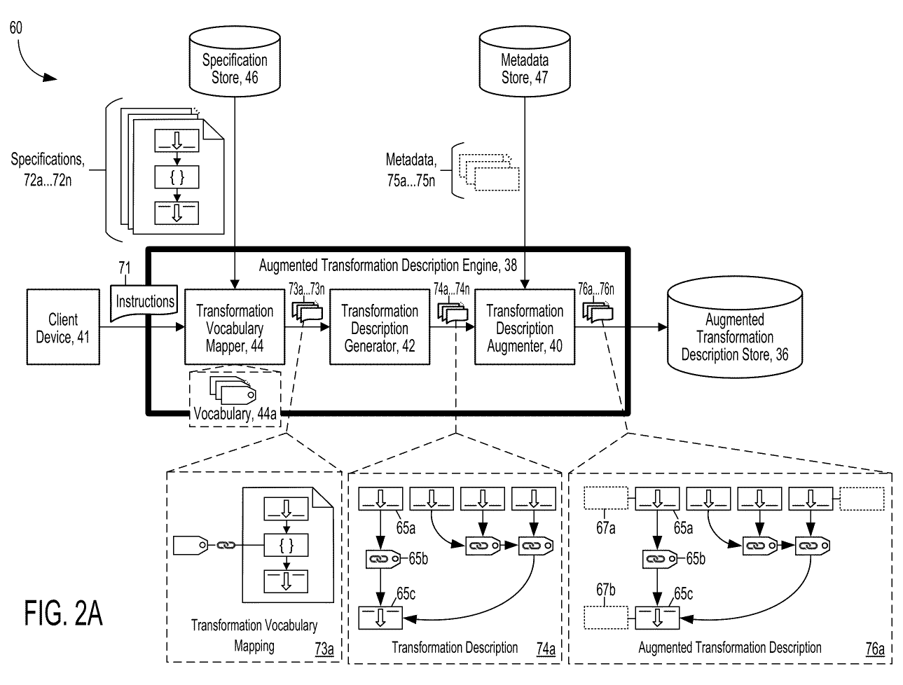

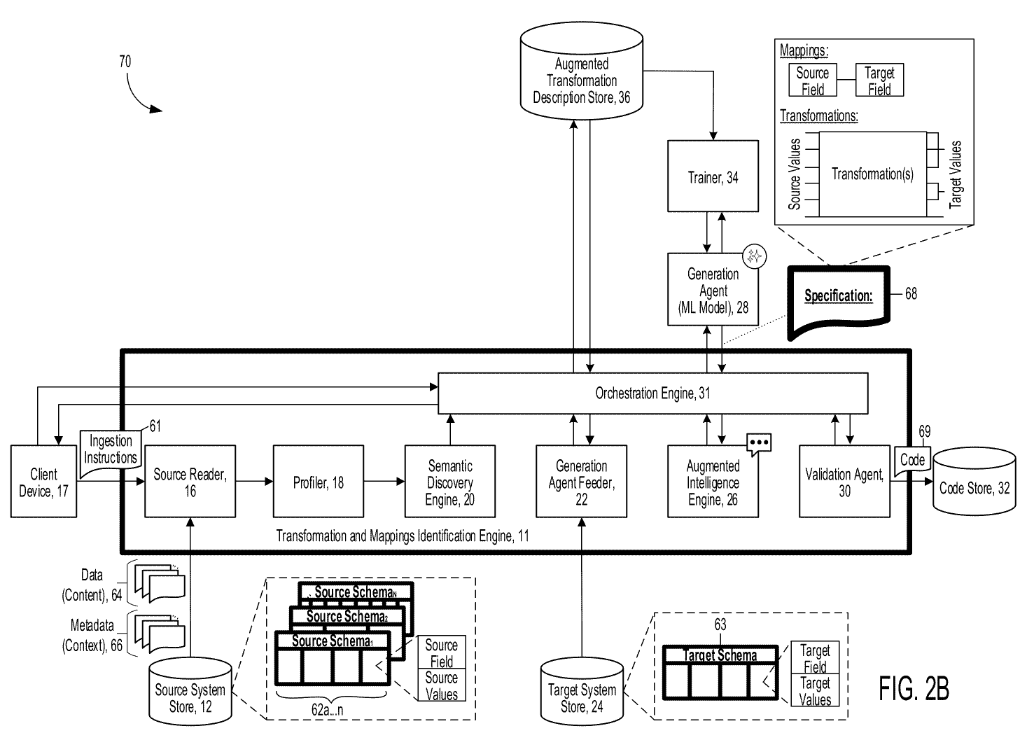

Referring to FIG. 2A, an environment 60 is shown for generating transformation descriptions, e.g., for training the generation agent 28. In this example, transformation vocabulary mapper 44 includes a vocabulary 44a that specifies various names that are available for performing the mappings. In this example, the vocabulary 44a is pre-loaded into the transformation vocabulary mapper 44. The transformation vocabulary includes the names in the vocabulary 44a.

In operation, the client device 41 transmits instructions 71 to initiate transformation description generation to the transformation vocabulary mapper 44. In response, the transformation vocabulary mapper 44 retrieves specifications 72a…72n from the specification store 46. Transformation vocabulary mapper 44 is configured to map the operations specified by specifications 72a…72n to the names in vocabulary 44a to generate mappings 73a…73n. For example, the transformation vocabulary mapper 44 can process (e.g., parse) the specification to identify one or more operations, and can link or otherwise associate each identified operation with a corresponding name in the transformation vocabulary 44a. A visualization of a mapping 73a is shown in FIG. 2A.

Transformation vocabulary mapper 44 transmits the mappings 73a…73n to transformation description generator 42. In this example, transformation description generator 42 generates transformation descriptions, e.g., descriptions of transformations among elements in specifications 72a…72n by mapping elements in specifications 72a…72n to the names in the transformation vocabulary specified in the mappings 73a…73n. An element may specify an input to a transformation or an output from a transformation. For example, based on at least one of specifications 72a…72n, transformation description generator 42 generates transformation description 74a with input box 65a, node 65b and output box 65c. In this example, input box 65a and output box 65c represent elements in a particular specification. In particular, input box 65a represents an input (e.g., an element in a specification that represents input). Output box 65c represents an output (e.g., an element in a specification that represents output). Node 65b represents the name in the transformation vocabulary that is mapped to operations in the specification, as will be described in more detail herein.

Transformation description generator 42 transmits transformation description 74a…74n to transformation description augmenter 40. Transformation description augmenter 40 augments transformation descriptions 74a…74n with metadata 75a…75n retrieved from metadata store 47 to provide context about source and target schemas, context about source and target datasets, and so forth. In this example, transformation description augmenter 40 augments transformation description 74a with metadata to generate augmented metadata description 76a. Augmented metadata description 76a includes boxes 67a, 67b that specify metadata about the elements represented by input box 65a and output box 65c, respectively. The metadata can specify a name (e.g., of an element in the specification or a field associated with that element), a data type, constraints, valid values, and so forth. The metadata may be included in specifications 72a…72n, and/or may be accessed from specification store 46, metadata store 47, and/or another data store. When the metadata is included in specifications 72a...72n, transformation vocabulary mapper 44 may be configured to transmit specifications 72a...72n to transformation description augmenter 40 – to enable identification of relevant metadata. In some examples, the transformation description augmenter 40 can obtain the metadata used to augment a given description by querying a model or other data source stored in, e.g., the metadata store 47 based on the inputs (e.g., the input associated with input box 65a) and/or the outputs (e.g., the output associated with output box 65c) specified in the specification. Example techniques for querying a model to obtain metadata are described in U.S. Patent No. 11,921,710, titled “Systems and methods for accessing data entities managed by a data processing system,” the entire contents of which is incorporated herein by reference.

In this example, transformation description augmenter 40 outputs augmented transformation descriptions 76a…76n to the augmented transformation description store36. Augmented transformation descriptions 76a…76n include augmented transformation description 76a. Trainer 34 can access augmented transformation descriptions 76a…76n as part of the process of training generation agent 28 (FIG. 1A). In particular, trainer 34 uses augmented transformation descriptions 76a…76n to train generation agent 28 (FIG. 1A) in identifying mappings and transformations to transform source data in accordance with a target schema, e.g., using reinforcement learning, among other techniques. To train generation agent 28 (FIG. 1A), training data also includes source datasets, source schemas and target schemas. In this example, trainer 34 feeds to generation agent 28 (FIG. 1A) source datasets (and associated source schemas), a target schema and augmented transformation descriptions. Using this fed information, generation agent 28 provides an output indicating proposed mappings and transformations to transform the source datasets in accordance with the target schema and trainer 34 provides feedback (e.g., using a reward function) that generation agent 28 (FIG. 1A) uses to improve its decision making.

Referring to FIG. 2B, environment 70 is shown for identification of source to target mappings and transformations. In particular, example inputs and outputs of environment 70 are shown. In this example, source system store 12 stores source schemas 62a…62n. Each of the source schemas 62a…62n can include a collection of datasets_{1…n} each having multiple data elements (e.g., fields or columns).

In operation, the client device 17 transmits ingestion instructions 61 to source reader 16. Generally, ingestion instructions 61 include instructions to access data and/or to commence an ingestion process, or otherwise initiate the transformation and mapping identification process. In this example, ingestion instructions 61 specify the source data to be ingested or accessed. Responsive to receipt of ingestion instructions 61, source reader 16 accesses from source system 12 data 64 and metadata 66. Data 64 includes data (e.g., datasets) specified by ingestion instructions 61. Metadata 66 includes metadata about data 64. In this example, metadata 66 includes source schemas 62a…62n that is associated with data 64. Target system 24 stores target schema 63. In this example, target schema 63 specifies the fields (and formats of those fields) of a target dataset. Target schema 63 includes a dataset with data elements 63a-63d. In this example, generation agent 28 identifies mappings among data elements in the source schemas 62a…62n and the target schema 63.

Based on data 64, metadata 66 and target schema 63, generation agent 28 generates specification 68. In this example, specification 68 specifies the mappings and transformations to produce target data (as specified by target schema 63) from data 64 (e.g., source data as defined by source schemas 62a…62n). In this example, validation agent 30 validates specification 68, as described in more detail herein. Upon successfully validating specification 68, validation agent 30 generates and transmits code 69 to code store 32. In this example, code 69 includes instructions for transforming source data (e.g., data 64) into target data as specified by target schema 63.

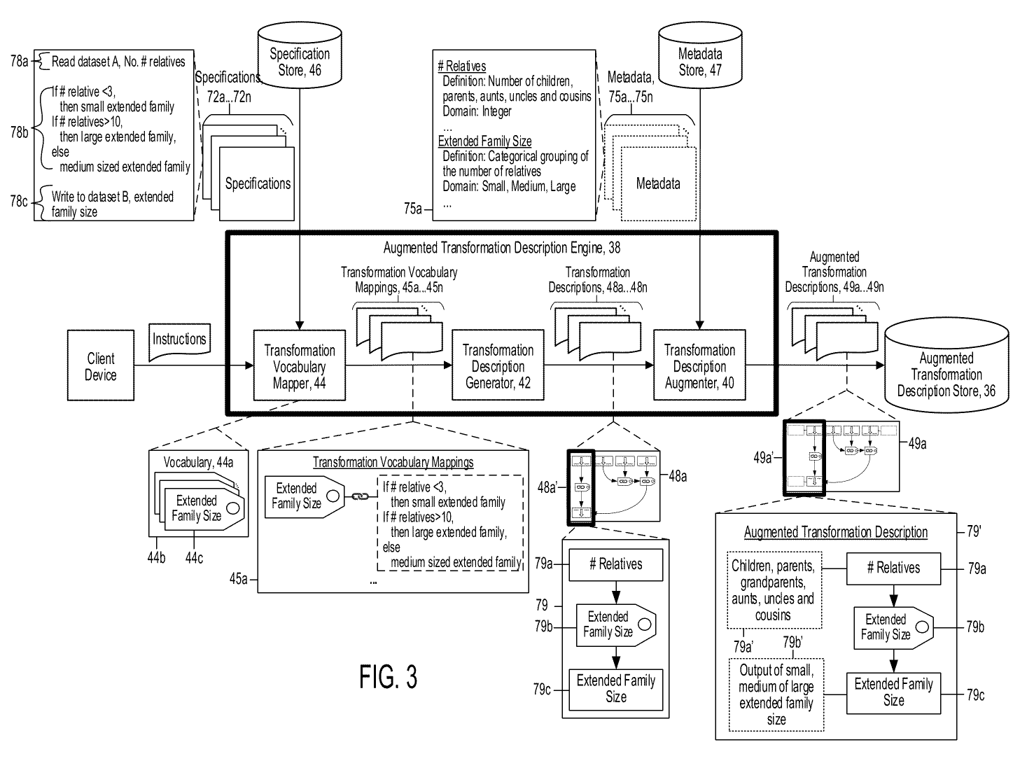

Referring to FIG. 3, a real-world example of generating an augmented transformation description is shown. In this example, content 78 of one of specifications 72a…72n is shown. Content 78 includes portions 78a, 78b and 78c. Portion 78a specifies an element indicating input (e.g., to operations). Portion 78b specifies operations to be performed. Portion 78c specifies an element indicating output (e.g., based on performance of the operations). In this example, content 44b of vocabulary 44a is shown. Content 44b specifies the names that are included in vocabulary 44a. Content 44b includes entry 44c specifying a name of “extended family size”.

Based on content 78 of the specifications 72a…72n and content 44b of vocabulary 44a, transformation vocabulary mapper 44 generates mappings 45a…45n, including a mapping 45a that specifies a mapping between the name of “extended family size” and the operations shown in portion 78b. In this example, transformation vocabulary mapper 44 is configured to identify which portions of the content 78 represent operations. Transformation vocabulary mapper 44 identifies the portion of content representing operations based on metadata included in content 78, profiling and/or performing semantic discovery on content 78, based on user input, by executing a ML model that is trained to identify portions of content representing operations, and so forth. In some examples, this identification can be performed by a parser within the transformation vocabulary mapper 44 that is configured to detect specific logical structures or control flow elements within the specification. For example, the parser can be configured to detect if-then statements, case statements, or mathematical operators that define how data is manipulated.

Transformation vocabulary mapper 44 then generates mapping 45a by associating a name (e.g., “extended family size”) with the identified operations. That is, mapping 45a effectively assigns a name to the operations shown in portion 78b. The name can be assigned to the operation in the mapping 45a using various techniques. For example, the name can be assigned via semantic discovery by labeling the identified operation with a semantic label selected from a data dictionary (e.g., the vocabulary 44a), where the label describes a practical or business meaning of the transformation logic. In another example, the name can be assigned to the operation based on user input or by executing a machine learning model trained to identify portions of content representing specific types of transformation operations. By assigning names to these operations, transformation vocabulary mapper 44 can establish an exhaustive vocabulary of operations, where each operation is given a name in this vocabulary. A sequence (or other collection) of names in this vocabulary of the transformation language can then be used to describe how data is transformed from a source schema to a target schema.

In this example, transformation vocabulary mapper 44 transmits mappings 45a…45n and the specifications 72a…72n to transformation description generator 42, which uses the mappings 45a…45n and the specifications 72a…72n to generate transformation descriptions 48a…48n. In particular, portion 48a’ of transformation description 48a is generated based on mapping 45a. Transformation description generator 42 is configured to detect elements (e.g., input to operations and output from operations) based on metadata included in content 78 of the specifications, parsing of content, detection of certain terms, detection of fields (and/or field names), profiling fields specified in content 78, performing semantic discovery on fields specified in content 78, and so forth. For example, transformation description generator 42 can parse content 78 to identify a “read” operation to identify input dataset A, a “write” operation to identify output dataset B, and intervening logic to identify transformations and mappings. In some examples, transformation description generator 42 executes a machine learning model trained to identify logical structures or specific operations within a specification.

A blow out of portion 48a’ is shown as transformation description 79 including input box 79a, node 79b, output box 79c and connecting edges. Input boxes (or output boxes) and edges represent data. In this example, transformation description 79 is a directed acyclic graph (DAG). Transformation description 79 is only a portion of complete transformations and mappings that are identified, e.g., from specifications 72a…72n. For example, the complete transformations and mappings identified may be represented as a collection of DAGs, a DAG of DAGs, and so forth.

In this example, input box 79a corresponds to the element (e.g., input) represented by portion 78a of content 78. Node 79b corresponds to the name (extended family size) mapped to the operations (represented in portion 78b of content 78). Output box 79c corresponds to the element (e.g., output) represented by portion 78c of content 78. In this example, transformation description generator 42 identifies in mapping 45a the name “extended family size” and generates node 79b to represent the name “extended family size”. Transformation description generator 42 parses content 78 to detect portions 78a, 78c as corresponding to elements for input and output, respectively. That is, transformation description generator 42 identifies a mapping for an input to and an output from these transformations (e.g., the transformations named “extended family size”). The mapping is between an input of “number of relatives” and an output of “extended family size.” As such, transformation description generator 42 generates input box 79a and output box 79c to represent this input and output, respectively.

To provide additional context, transformation description augmenter 40 augments the transformation descriptions 48a…48n with metadata 75a…75n about the physical datasets, e.g., entered by users, imported from source systems, or derived via semantic discovery. In this example, content 78 specifies the physical dataset (i.e., dataset A) from which data is read and the physical dataset (i.e., dataset B) to which data is written. As such, transformation description augmenter 40 can access from one or more external data stores (e.g., metadata store 47) metadata 75a for those physical datasets. In this example, transformation description augmenter 40 generates augmented transformation descriptions 49a…49n, where augmented transformation description 49a is a version of transformation description 48a that has been augmented with metadata. As shown in blow out 79’, a portion 49a’ of augmented transformation description 49a (corresponding to the portion 48a’ of transformation description 48a) includes boxes 79a’, 79b’, each which specifies metadata for input box 79a and output box 79c – respectively.

Transformation description augmenter 40 transmits augmented transformation descriptions 49a…49n to storage device 36. In turn, trainer 34 accesses augmented transformation descriptions 49a…49n and uses augmented transformation descriptions 49a…49n to train generation agent 28 or an ML model thereof (e.g., FIG. 1A, FIG. 2A). Once generation agent 28 has been trained on augmented transformation descriptions 49a…49n (and other augmented transformation descriptions), generation agent 28 can identify mappings and transformations for a new source data. In this example, generation agent 28 is trained on a target schema (e.g., target schema 63) and/or a target value domain using augmented transformation descriptions that are similar, related, and so forth to the target schema and/or the target value domain. For example, after generation agent 28 has been trained on augmented transformation descriptions 49a…49n (among other augmented transformation descriptions), generation agent 28 can identify mappings and transformations for source data specifying a number of children to target data specifying a family size, as described below.

Augmented transformation description engine 38 generates enough transformation descriptions (e.g., specifying mappings and named operations or sequences of operations) in this transformation language to do a domain specific training for generation agent 28 (FIG. 1A) to handle this vocabulary of transformations, mapping from datasets enriched with metadata to a specific target schema. Then, presented with a new set of inputs aimed at a target schema (that generation agent 28 has been trained on), the system described herein uses semantic discovery to enrich the metadata about the data in its raw format, and uses (trained) generation agent 28 to propose a transformation sequence (or a transformation) with mappings to produce outputs in accordance with the target schema. In this way, the process of building a data warehouse (or data lake) is automated, e.g., with a trained LLM, as described now.

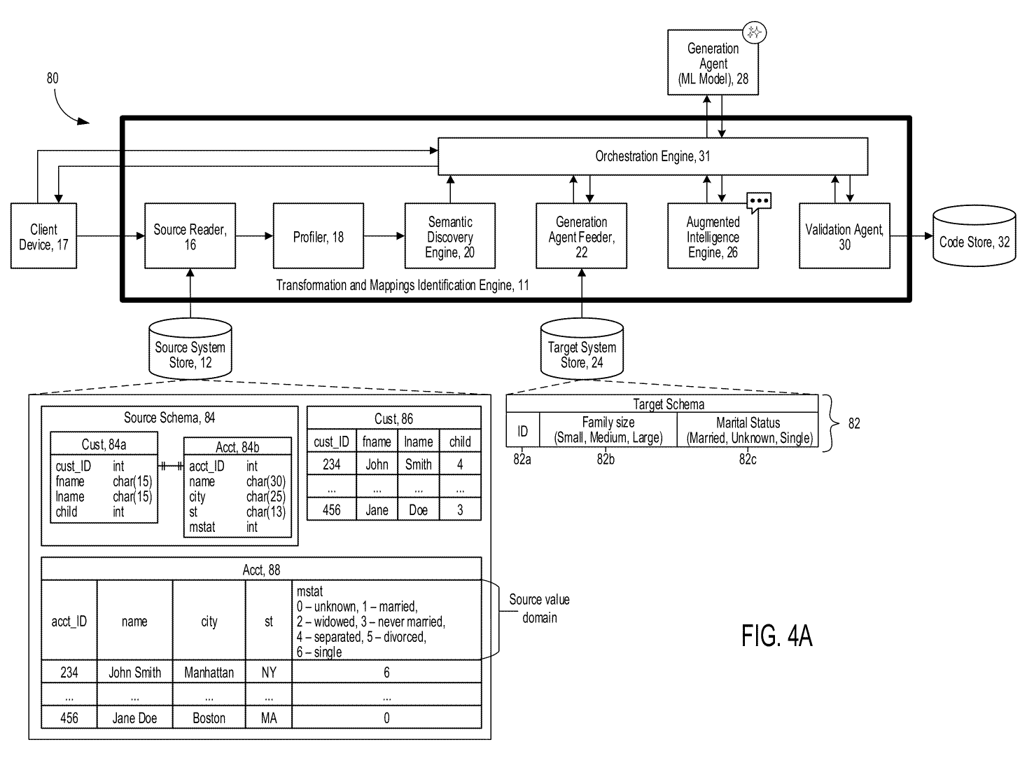

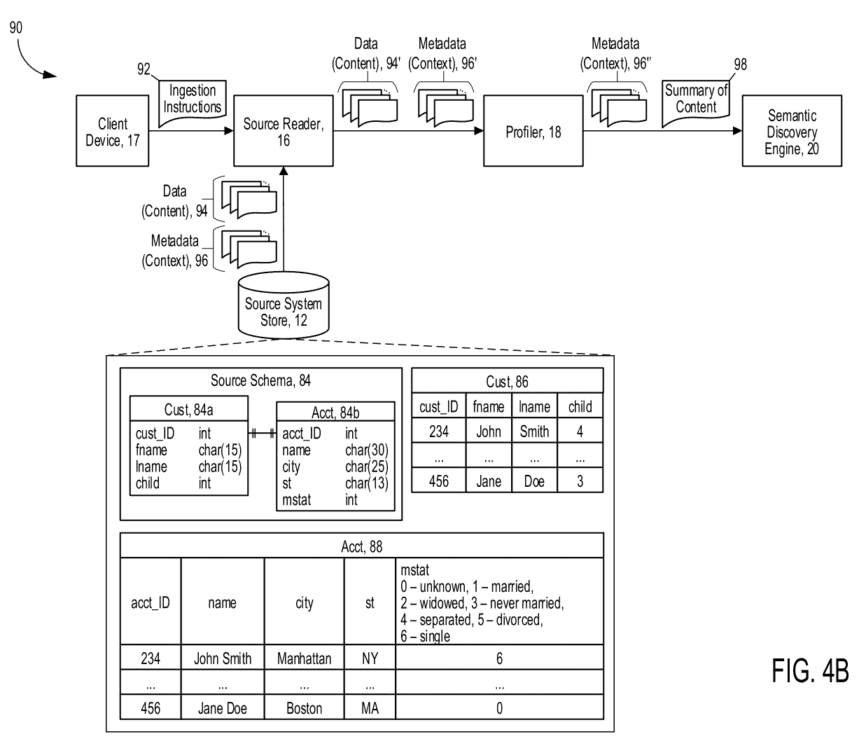

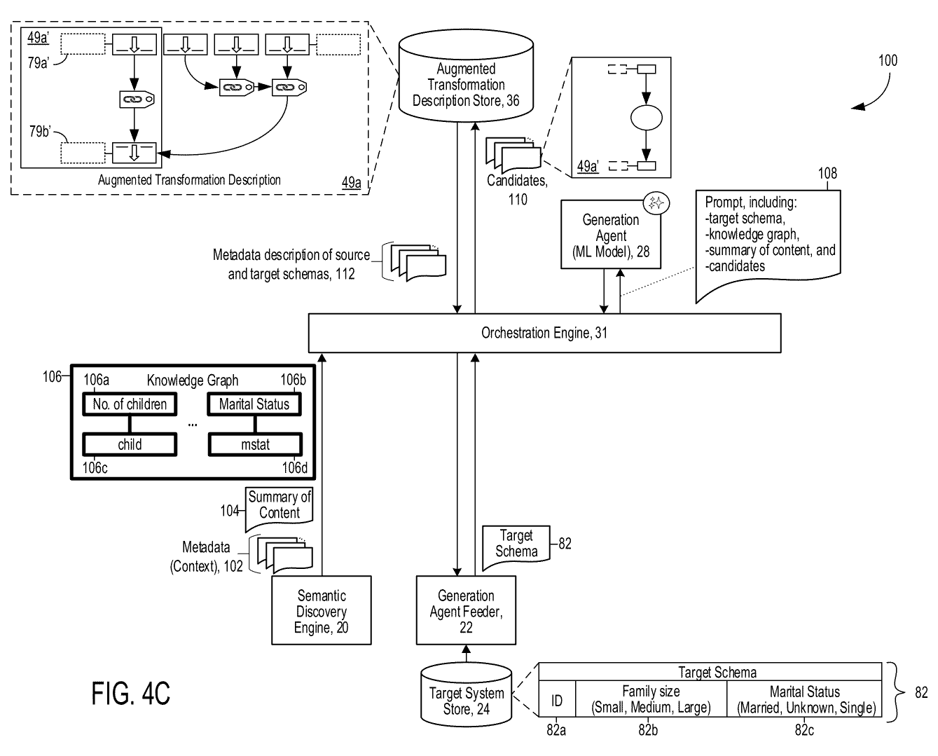

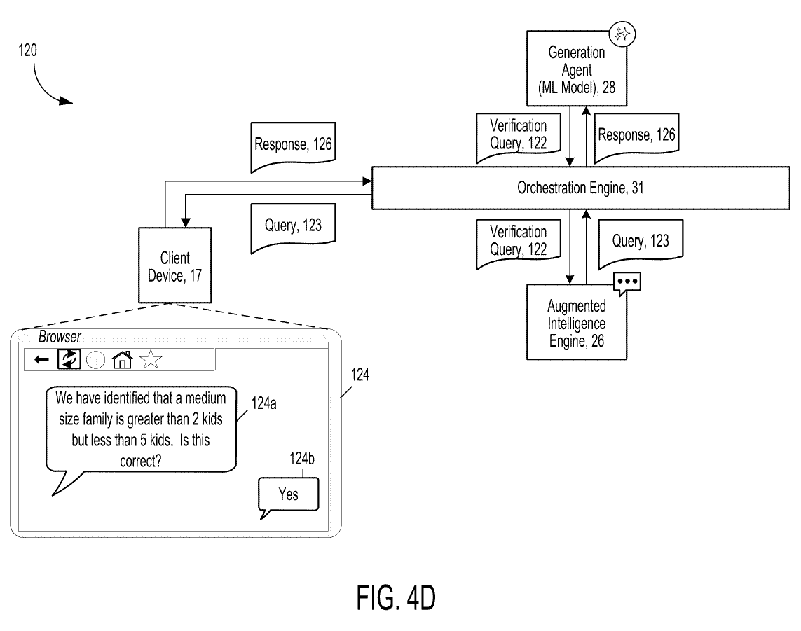

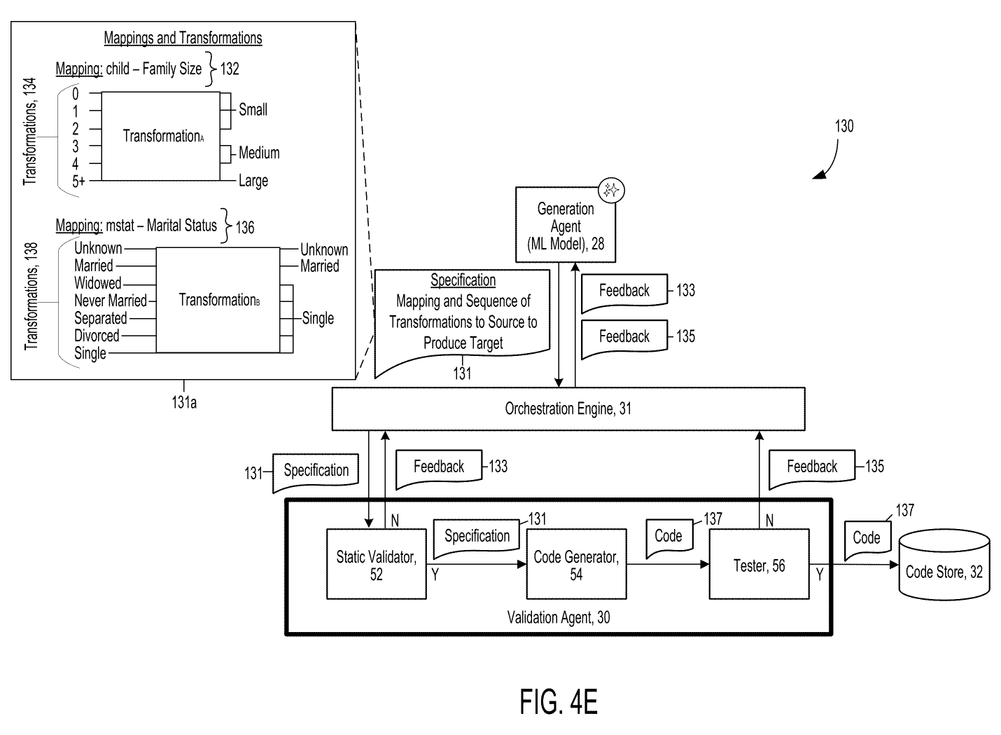

Referring to FIG. 4A, environment 80 for identification of source to target mappings and transformations is shown. In this example, source system store 12 stores source datasets 86, 88. Source dataset 86 is structured with fields, including a “cust_ID” field and a “child” field. Source dataset 88 is also structured with fields, including an “acct_ID” field and a “mstat” field. In this example, the mstat field has a source value domain, as follows: 0 – unknown, 1 – married, 2 – widowed, 3 – never married, 4 – separated, 5 – divorced and 6 – single. Source system 12 also stores source schema 84 with entities 84a, 84b (e.g., tables). In this example, entity 84a describes the fields of source dataset 86 and entity 84b describes the fields of source dataset 88. The relationship line between entities 84a, 84b specifies that source dataset 86 (represented by entity 84a) is related to source dataset 88 (represented by entity 84b) through a primary-foreign key relationship between the cust_ID field and the acct_ID field. In this example, the relationship line further specifies that the cardinality between the source datasets 86, 88 is one-to-one, meaning each record in source dataset 86 is related to one record in source dataset 88.

Target system 24 stores target schema 82 (e.g., a target data model) specifying fields 82a, 82b, 82c. In this example, field 82a has a name of ID. Field 82b has a name of family size. The target value domain for field 82b is small, medium, large. Field 82c has a name of marital status and a target value domain of married, unknown, single. For purposes of convenience and understanding, the target value domain is shown within the respective fields 82b, 82c of the target schema 82. However, the target value domain may be specified elsewhere in the target schema 82 (or another entity in the target system) in some examples.

Referring to FIG. 4B, environment 90 for identification of source to target mappings and transformations is shown. In this example, client device 17 transmits ingestion instructions 92 to source reader 16. Ingestion instructions 92 specify that source datasets 86, 88 are to be accessed (e.g., ingested). Responsive to receipt of ingestion instructions 92, source reader 16 requests source datasets 86, 88 from source system store 12. In response, source system store 12 transmits data 94 (e.g., source datasets 86, 88) and metadata 96 (e.g., source schema 84) to source reader 16. In turn, source reader 16 transmits data 94’ (e.g., data 94 or a copy of data 94) and metadata 96’ (e.g., metadata 96 or a copy of metadata 96) to profiler 18. Profiler 18 profiles data 94’ and outputs summary 98, including, e.g., a summary of the profiled data.

In particular, profiler 18 generates profile information including field profiles for the child field in source dataset 86 and the mstat field in source dataset 88. The field profile for the child field specifies the type of values in the field, the name of the field, a count of how many times a particular value occurs in the field, and so forth. The field profile for the mstat field specifies the type of values in the field, the name of the field, a count of how many times a particular value occurs in the field, and so forth. In some examples, the profile information includes maximum, minimum, and mean values occurring in a field, and samples of the least common and most common values occurring in that field. Summary 98 includes the generated profile information, e.g., the field profiles. Profiler 18 transmits summary 98 and metadata 96’’ to semantic discovery engine 20. In this example, metadata 96’’ may be metadata 96, metadata 96,’ a copy of metadata 96’ and so forth. Using metadata 96’’ and summary 98, semantic discovery engine 20 performs semantic discovery on the fields and values of data 94 as specified by summary 98.

In particular, semantic discovery engine 20 receives summary 98 and metadata 96’’ and determines a semantic meaning of the fields in source datasets 86, 88. To determine the semantic meaning of the fields of source datasets 86, 88, semantic discovery engine 20 performs classifications that analyze the profile information (including statistics of values of the fields) included in summary 98 and that further analyze metadata 96’’ that provides context for the fields and the values of the fields. The classifications of the profile information and the metadata 96’’ enable semantic discovery engine 20 to determine what attributes are most associated with a field. Attributes include metadata (or other data) that indicate properties of a given field. For example, attributes can indicate a particular format, a particular relationship of the field with another field or fields, allowed or prohibited values for the field, associated key terms or business terms, statistical criteria for the value(s) of the associated field (either individually, in relation to other values of the field, or for the values of the field as a group), and so forth. Based on determined attributes for a field, semantic discovery engine 20 identifies a label, from the data dictionary database, and associates that field with the label. In some examples, to generate the association, semantic discovery engine generates a label index with an entry specifying the label, the field name (from the source dataset) and the association between the label and the field name. In this example, semantic discovery engine 20 assigns a label of “Marital Status” to the mstat field and a label of “No. of children” to the child field.

Referring to FIG. 4C, environment 100 for identification of source to target mappings and transformations is shown. Using the assigned labels, semantic discovery engine 20 generates knowledge graph 106. Generally, a knowledge graph includes a data model that models information (e.g., names, labels and so forth) as nodes and their relationships as edges. In this example, knowledge graph 106 includes nodes 106a-106d. Node 106a is related to node 106c to indicate the label of “No. of children” is related to the field name of “child.” Node 106bis related to node 106d to indicate the label of “Marital Status” is related to the field name of “mstat.” Semantic discovery engine 20 transmits metadata 102, summary 104 and knowledge graph 106 to the orchestration engine 31. In this example, metadata 102 may be any version of metadata previously described (e.g., metadata 96, 96’ or 96’’) or a copy of metadata previously described (e.g., a copy of metadata 96, 96’ or 96’’). Metadata 102 includes source schema 84 (FIG. 4A). Summary 104 may be summary 98 or a copy of summary 98.

Orchestration engine 31 is configured to generate a prompt for submission to generation agent 28. To generate the prompt, the orchestration engine receives from generation agent feeder 22 the target schema 82 stored in the target system store 24. In some examples, orchestration engine 31 also identifies candidate mappings and transformations (e.g., which the generation agent 28 can use to identify or select appropriate mappings and transformations). To do so, orchestration engine 31 transmits metadata 112 to augmented transformation description store 36. Metadata 112 includes a description of the source and target schemas. Orchestration engine 31 generates metadata 112 using at least metadata 102 (and/or knowledge graph 106) and target schema 82. Using metadata 112, augmented transformation description store 36 performs a semantic search of the stored transformation descriptions to identify one or more transformation descriptions that are candidates for describing how to transform datasets that are in accordance with source schema 84 (FIG. 4A) to target schema 82. In some examples, augmented transformation description store 36 performs the semantic search by doing an intelligent lookup by matching terms in metadata 112 with terms in nodes (e.g., nodes specifying metadata) of transformation descriptions, by identifying terms in metadata 112 that are analogous to terms in nodes of the transformation descriptions, by performing fuzzing matching on terms in metadata 112 and terms in nodes of the transformation descriptions, and so forth.

In this example, transformation description 49a has analogies to metadata 112. In particular, box 79a’ specifies that the input to the transformation is a value representing a number of children, parents, grandparents, aunts, uncles and cousins, as previously described in FIG. 3. Box 79b’ specifies an extended family size, as previously described in FIG. 3. Augmented transformation description store 36 performs the intelligent lookup to identify that the field name “child” is related to the metadata specified by box 79a’. Additionally, augmented transformation description store 36 identifies that the field name “family size” (as specified by target schema 82) is related to the metadata specified by box 79b’. As such, augmented transformation description store 36 identifies transformation description 49a as a candidate. In particular, augmented transformation description store 36 identifies portion 49a’ of transformation description 49a as being a candidate. In some examples, augmented transformation description store 36 identifies a plurality of candidates. Rather than representing a transformation description, a candidate can also represent inputs or outputs (e.g., as represented in a transformation description) that are analogous to source and/or target schemas. In some examples, orchestration engine 31 may perform the perform the semantic search, such as part of an retrieval augmented generation (RAG) process.

Augmented transformation description store 36 transmits candidates 110 to orchestration engine 31. In this example, one of the candidates 110 specifies portion 49a’ of augmented transformation description 49a. In this example, augmented transformation description 49a is represented as a DAG. A transformation description can also be represented in other forms, including, e.g., a summary or written form.

Using candidates 110, target schema 82, knowledge graph 106, and summary 104, orchestration engine 31 generates a prompt 108 that specifies candidates 110, target schema 82, knowledge graph 106, and summary 104. In this example, fields in source datasets 86, 88 that are not used by target schema 82 may still be included in knowledge graph 106 and represented in metadata 102 and summary 104 to further assist orchestration engine 31 in performing a semantic search for analogous transformation descriptions. Prompt 108 may also include additional information, including, e.g., a request to recommend mappings and transformations to transform source datasets (in the source schema) to the target schema. Orchestration engine 31 transmits prompt 108 to generation agent 28. Generation agent 28 uses prompt 108 to identify mappings and transformations to transform data from the source schema to the target schema. For example, generation agent 28 may generate mappings and transformations that are modifications of (and/or versions of) the mappings and transformations specified by portion 49a’ of transformation description 49a, based on the contents of prompt 108. However, there may be some fields for which generation agent 28 seeks confirmation that it has correctly identified a transformation, e.g., between values in fields and an appropriate value associated with the target schema (e.g., a value in a target value domain associated with the target schema). For example, generation agent 28 may need confirmation on the number of children to qualify for a medium family size.

Referring to FIG. 4D, environment 120 is shown for generation agent 28 to receive feedback on a proposed transformation. In this example, generation agent 28 transmits verification query 122 to the augmented intelligence engine 26 via the orchestration engine. Verification query 122 includes a request to verify that a medium size family has more than two children but less than five children. Augmented intelligence engine 26 in turn transmits a query 123 configured to render, on a display of the client device 17, a graphical user interface 124 with visualization 124a, which prompts a user to confirm if it is correct that a medium size family has more than two children but less than five children. In this example, the user confirms that it is correct, as indicated by visualization 124b in graphical user interface 124. In response, client device 17 transmits response 126 to the generation agent 28 via the orchestration engine 31. Response 126 indicates that it is correct that a medium size family has more than two children but less than five children. While the query 123 is described as being configured to render a GUI, the query 123 can take other forms in other examples, such as where the client device 17 corresponds to a software component rather than a user-facing device.

Referring to FIG. 4E, environment 130 is shown for identification of source to target mappings and transformations. In this example, generation agent 28 generates specification 131, the contents of which are shown in blow out 131a. In this example, specification 131 specifies the mappings and transformations for transforming source datasets 86, 88 (FIG. 4A) in accordance with target schema 82 (FIG. 4A). Generation agent 28 generates the mappings and transformations using prompt 108 (FIG. 4C). In particular, based on its training, generation agent 28 identifies mapping 132 between the field name “child” in source dataset 86 (FIG. 4A) and the field name “family size” in target schema 82 (FIG. 4A). Generation agent 28 is able to identify this mapping at least partly based on knowledge graph 106 that specifies that the semantic meaning of the “child” field is a number of children. Generation agent 28 also identifies transformations 134 that specify how to transform the values in the child field of source dataset 86 in accordance with target schema 82. In particular, generation agent 28 may use the logic specified by portion 76d of transformation description 76 (FIG. 4C) as a model for generating logic to determine family size based on number of children. In some examples, transformations 134 may include a cross table lookup to identify family size based on a number of children. In another example, transformations 134 include conditional logic, e.g., logic specifying that if the number of children is less than three, then the family size is small, if the number of children is five or greater, then the family size is large, else the family size is medium.

Generation agent 28 also generates mapping 136 between the mstat field in source dataset 88 (FIG. 4A) and the marital status field in target schema 82, using the techniques described herein. Generation agent 28 also identifies transformations 138 that specify how to transform the values in the mstat field of source dataset 88 in accordance with target schema 82, using the techniques described herein. In this example, candidates 110 (FIG. 4C) include a transformation description that is analogous to transforming numerical values of marital status to string values of married, unknown and single. Generation agent 28 uses this transformation description in generating transformations 138.

Generation agent 28 transmits specification 131 to the orchestration engine 31, which in turn transmits it to the static validator 52 to perform static validation on the specification 131. In particular, static validator 52 validates that specification 131 complies with certain requirements, standards, criteria, and so forth. If static validator 52 determines that specification 131 does not comply (with these requirements, standards, criteria, and so forth), static validator 52 transmits feedback 133 to generation agent 28 via the orchestration engine 31. The feedback 133 indicates how the specification 131 does not comply so that generation agent 28 can address the issue. Generation agent 28 can correct the issue and send a revised specification (not shown) to static validator 52. This feedback loop continues until static validator 52 confirms that a received specification complies with certain requirements, standards, criteria, and so forth.

If static validator 52 confirms that specification 131 is in compliance, static validator 52 transmits specification 131 to code generator 54 to generate code 137 (e.g., executable instructions). The process of generating code from a specification is described in U.S. Patent No. 11,423,083, titled “Transforming a Specification into a Persistent Computer Program,” the entire contents of which are incorporated herein by reference. Tester 56 tests code 137. In some examples, the generated code 137 may include a dataflow graph (e.g., a computational graph) that is compiled for execution, such as described in U.S. Patent No. 11,423,083. Upon detection of an error, tester 56 transmits feedback 135 to generation agent 28 via the orchestration engine 31. In an example, feedback 135 may indicate that an output of code 137 does not satisfy one or more criteria of expected output. In this example, tester 56 receives an indication of expected results of the mappings and transformations. For example, tester 56 may receive or be pre-loaded with a target schema and a target domain value (or a collection of target domain values). In this example, tester 56 executes code 137 to determine whether an output of execution of code 137 is in accordance with the target schema and the target domain value. When the output of execution of code 137 is not in accordance with the target schema and/or the target domain value, feedback 135 indicates the nature of the error, e.g., by indicating which fields in the output and/or which values in the output are not in accordance with the target schema and/or the target domain value. Based on feedback 135, generation agent 28 re-generates the specification, which is used to re-generate the code for testing by the tester 56. This process continues until tester 56 determines no errors.

In this example, tester 56 determines that code 137 has no errors. As such, tester 56 transmits code 137 to code store 32 for storage of code 137. Code 137 can be retrieved from code store 32, e.g., by a data processing system, and executed to automatically access source datasets 86, 88, ingest them and store them in accordance with target schema 82 (FIG. 4C).

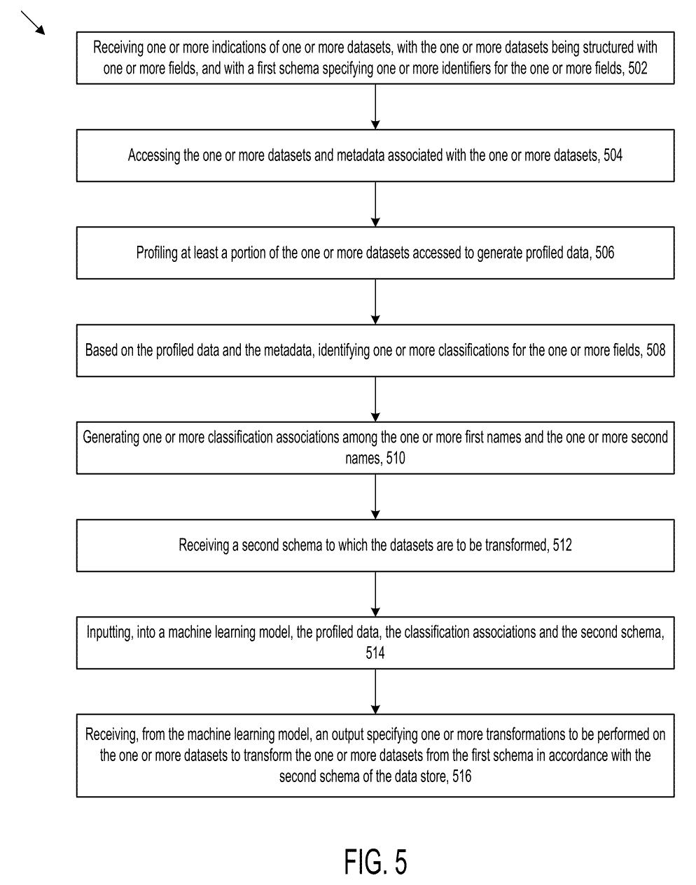

Referring to FIG. 5, flow diagram 500 is shown for using a machine learning model to automatically identify mappings and transformations to map and transform datasets from a first schema to a second schema. In operation, a data processing system receives (502) one or more indications of one or more datasets associated with a first schema (e.g., a source schema) to be transformed in accordance with a second schema (e.g., a target schema), with the one or more datasets being structured with one or more fields and with the first schema specifying one or more identifiers for the one or more fields. Responsive to the one or more indications, the data processing system accesses (504) the one or more datasets and metadata associated with the one or more datasets. The data processing system profiles (506) at least a portion of the one or more datasets accessed to generate profiled data.

Based on the profiled data and the metadata, the data processing system identifies (508) one or more classifications for the one or more fields. In an example, a classification specifies a semantic meaning of values of the field. For example, the classification can describe a type of content represented by the values of the field. The data processing system generates (510) one or more classification associations among the one or more identifiers and the one or more classifications, wherein a given identifier of the one or more identifiers is associated with a given classification of the one or more classifications, wherein the given identifier is associated with a given field of the one or more fields, and wherein the given classification classifies the given field associated with the given identifier.

The data processing system receives (512) a second schema to which the datasets are to be transformed in accordance with. The data processing system inputs (514), into a ML model, the profiled data, the classification associations, and the second schema. The data processing system receives (516), from the ML model, an output specifying one or more mappings and one or more transformations to be performed on the one or more datasets to map and transform the one or more datasets from being in accordance with the first schema to being in accordance with the second schema. For example, the data processing system receives an output specifying one or more mappings among fields in the source schema and fields in the target schema and one or more transformations to be performed on the one or more datasets to transform (e.g., map and transform) the one or more datasets from being in accordance with the source schema (and source value domain) to being in accordance with the target schema (and target value domain). Generally, map and transform may be collectively referred to as transform, without limitation and for purposes of convenience.

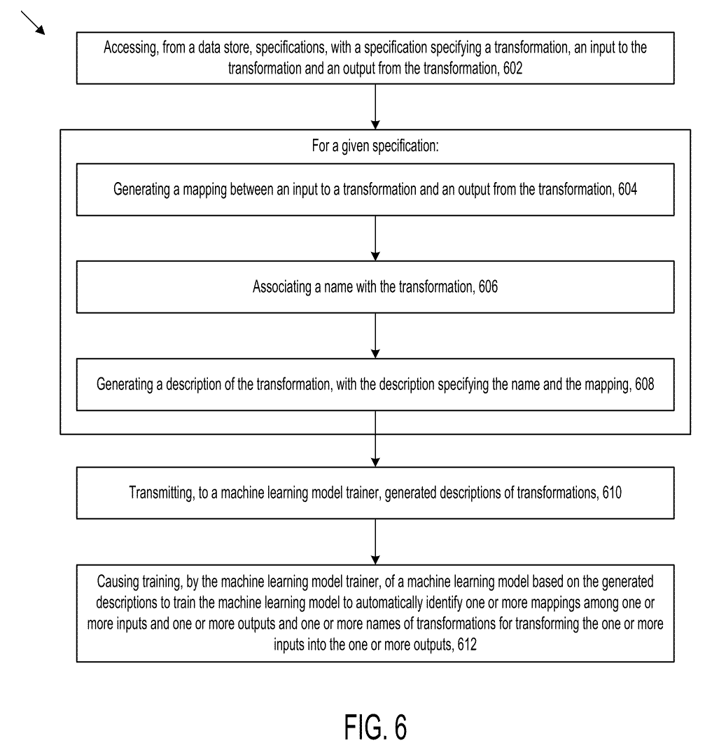

Referring to FIG. 6, flow diagram 600 is shown for training a machine learning model to automatically identify mappings and transformations for mapping and transforming datasets from one schema (e.g., a source schema) to another schema (e.g., a target schema). In operation, a data processing system access (602), from a data store, specifications, with a specification specifying a transformation, an input to the transformation and an output from the transformation. For a given specification, the data processing system: generates (604) a mapping between an input to a transformation and an output from the transformation; associates (606) a name with the transformation; and generates (608) a description of the transformation, with the description specifying the name and the mapping.

The data processing system transmits (610), to a machine learning model trainer, generated descriptions of transformations. The machine learning model trainer causes training (612) of a machine learning model based on the generated descriptions to train the machine learning model to automatically identify one or more mappings among one or more inputs and one or more outputs and one or more names of transformations for transforming the one or more inputs into the one or more outputs.

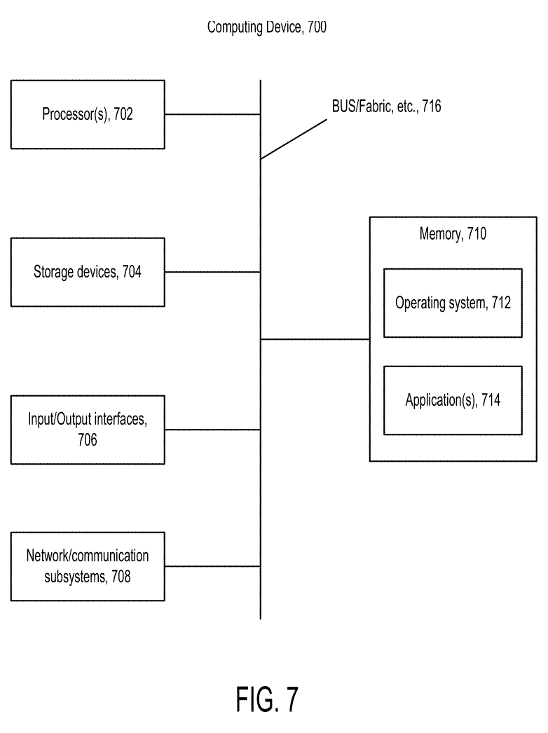

Referring to FIG. 7, an example operating environment for implementing embodiments of the present invention is shown and designated generally as computing device 700. Elements of a computing device 700 or a computer or data processing system or client or server include one or more programmable processors 702 (and/or processing devices) for performing actions in accordance with instructions and one or more memory devices 710 for storing instructions and data. Generally, a computer will also include, or be operatively coupled, (via bus 716, fabric, network, etc.) to I/O interfaces 706, e.g., display devices, network/communication subsystems, etc. (not shown) and one or more mass storage devices 704 for storing data and instructions, etc., and a network communication subsystem 708, which are powered by a power supply (not shown). In memory devices 710, are an operating system 712 and applications 714 for application programming.

The computer program instructions and data may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium or machine-readable hardware storage device (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is stored on or downloaded (from a cloud computing infrastructure or other remote source) to a computer-readable storage medium (e.g., solid state memory or media, or magnetic or optical media) of a storage device accessible by a general or special purpose programmable computer, for configuring and operating the computer when the storage device medium is read by the computer to perform the processing described herein. Each such computer program may also be accessed as a service provided by cloud computing infrastructure. The embodiments described herein may also be implemented as a tangible, non-transitory medium, configured with a computer program, where the medium so configured causes a computer to operate in a specific and predefined manner to perform one or more of the processing steps described herein.

The computer program may include one or more modules of a larger program, for example, which provides services related to the design, configuration, and execution of dataflow graphs. The modules of the program (e.g., elements of a dataflow graph) can be implemented as data structures or other organized data conforming to a data model stored in a data repository.

To provide for interaction with a user, embodiments of the subject matter described in this specification can be implemented on a computer having a display device (monitor) for displaying information to the user, and a keyboard and a pointing device, (e.g., a mouse or a trackball) by which the user can provide input to the computer. In addition, a computer can interact with a user by sending documents to and receiving documents from a device that is used by the user (for example, by sending web pages to a web browser on a user’s device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

A computation can be expressed as data flow through a computational graph with nodes and links. The computation includes components specifying portions of the computation. A node represents one or more of these components. The nodes are connected by the links to represent data flow, such as flow of data records, among the components. As such, a computational graph may also be referred to as a dataflow graph. The dataflow graph itself is executable, e.g., by compiling or otherwise processing the dataflow graph to generate executable computer code.

As described herein, dataflow graph components include data processing components and/or datasets. A dataflow graph can be represented by a directed graph that includes nodes or vertices, representing the dataflow graph components, connected by directed links or data flow connections, representing flows of work elements (i.e., data) between the dataflow graph components. The data processing components include code for processing data from at least one data input, (e.g., a data source) and providing data to at least one data output, (e.g., a data sink) of a system. The dataflow graph can thus implement a graph-based computation performed on data flowing from one or more input datasets through the graph components to one or more output datasets.

A component may be an upstream component, a downstream component, or both. An upstream component includes a component that outputs data to another component. A downstream component includes a component that receives data from another component. Additionally, components include input and output ports. The links are directed links that are coupled from an output port of an upstream component to an input port of a downstream component. The ports have indicators that represent characteristics of how data is written to and read from the links and/or how the components are controlled to process data.

These ports may have various characteristics. For example, one characteristic of a port is its directionality as an input port or output port. The directed links represent data and/or control being conveyed from an output port of an upstream component to an input port of a downstream component.

A subset of the components serves as sources and/or sinks of data from the overall computation, for example, to and/or from data files, database tables, and external data flows. Parallelism can be achieved at least by enabling different components to be executed in parallel by different processes (hosted on the same or different server computers or processor cores), where different components executing in parallel on different paths through a dataflow graph is referred to as component parallelism, and different components executing in parallel on different portions of the same path through a dataflow graph is referred to as pipeline parallelism.

A system also includes a data processing system for executing one or more computer programs (such as dataflow graphs), which were generated by the transformation of a specification into the computer program(s) using a transform generator. In some examples, the transform generator may transform a specification into entity, e.g., by selecting from a data repository those dataflow graph components or data representing components that are specified by the operation types in the specification. Generally, an “entity” includes a portion of a computer program (e.g., a pre-defined portion of a computer program for inclusion in another computer program) or one or more dataflow graph components (e.g., that are encapsulated together into a pre-defined module).

The transform generator may also access, in a data storage system, a data structure that maps data representing portions of a specification to data representing components or dataflow graph components. Transform generator identifies, in the mapping, an item of data representing a particular portion of the specification. Transform generator identifies, in the mapping, which data representing a component or a dataflow graph component is mapped to the identified portion of the specification; and adds the identified data representing component or dataflow graph component to the entity.

Various machine learning models and agents described herein, such as the generation agent 28, can be implemented using high-capacity neural network architectures. In some examples, these models are configured as transformer-based architectures comprising one or more attention mechanisms, such as multi-head self-attention, which enable the model to identify and weigh relationships between disparate elements in an input sequence (e.g., mapping a source field name to a target schema requirement). The architecture of these machine learning models can include an input embedding layer configured to map discrete tokens into a continuous vector space (e.g., a latent space). The models can further comprise a plurality of processing layers, such as feed-forward neural networks, normalization layers, and residual connections, configured to extract high-level features and logical dependencies from the input data. A final output layer, such as a softmax layer or a linear transformation layer, can be used to generate a probability distribution over a set of potential output tokens or structured data elements.

Training of these machine learning models can involve a multi-phase process. A pre-training phase can include training a model on a large corpus of data to learn general-purpose patterns, linguistic structures, and logical reasoning. A subsequent fine-tuning phase can involve supervised fine-tuning (SFT) using domain-specific datasets, such as the augmented transformation descriptions 37a…37n. During fine-tuning, the parameters of the model are adjusted (e.g., via stochastic gradient descent or parameter-efficient fine-tuning (PEFT) techniques) to minimize a loss function, thereby specializing the model for data transformation and mapping tasks. In some implementations, the models are further refined using reinforcement learning (e.g., reinforcement learning from human feedback (RLHF)), where a reward model provides feedback based on the accuracy or executable validity of the model’s outputs. The machine learning models and agents can be executed on specialized hardware, such as one or more graphics processing units (GPUs), field-programmable gate arrays (FPGAs), or application-specific integrated circuits (ASICs) (e.g., tensor processing units (TPUs)), which are optimized for the parallelized matrix operations required for neural network inference and training.

The techniques described herein may have numerous advantages. For example, these techniques may be able to improve data quality and data integrity (e.g., accuracy, consistency, completeness, and reliability of data) by potentially avoiding (or reducing) erroneous transformations from the source to the target. Additionally, because the techniques described herein understand the semantic meaning of the underlying data, these techniques could be able to identify more accurate mappings and transformations to the target schema. The techniques described herein may improve computational efficiency by likely avoiding (or reducing) erroneous data processing operations that could waste computing resources. For example, because the techniques described herein may identify mappings and transformations with greater accuracy, fewer unnecessary or incorrect operations due to erroneous mappings or transformations would likely need to be performed, thereby potentially preventing the waste of computing resources on these unnecessary or incorrect operations. The techniques described herein may also improve data security by using metadata and data profiles to determine mappings and transformations without feeding a ML model the data itself (which may contain personally identifiable information (PII)). Additionally, since the techniques described herein leverage AI models, there may be greater consistency among the mapping and transformations across use cases, which could allow for improved error traceability and root cause analysis. For example, because an AI model may generate more consistent mappings and transformations, errors in these mappings or transformations could be more easily identified and corrected, as these errors likely occur consistently across use cases. That is, when mappings and transformations are produced with greater variability, more points of failure are likely to be introduced – potentially making error identification more difficult.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program. Accordingly, other embodiments are within the scope of the following claims.

What is claimed is:

1. A computer-implemented method for using a machine learning model to automatically identify mappings and transformations to map and transform datasets from a first schema to a second schema, including:
receiving one or more indications of one or more datasets, with the one or more datasets being structured with one or more fields, and with a first schema specifying one or more identifiers for the one or more fields;
responsive to the one or more indications, accessing the one or more datasets and metadata associated with the one or more datasets;
profiling at least a portion of the one or more datasets accessed to generate profiled data;
based on the profiled data and the metadata, identifying one or more classifications for the one or more fields;
generating one or more classification associations among the one or more identifiers and the one or more classifications, wherein a given identifier of the one or more identifiers is associated with a given classification of the one or more classifications, wherein the given identifier is associated with a given field of the one or more fields, and wherein the given classification classifies the given field associated with the given identifier;
receiving a second schema to which the datasets are to be transformed;
inputting, into a machine learning model, the profiled data, the classification associations and the second schema; and
receiving, from the machine learning model, an output specifying one or more mappings and one or more transformations to be performed on the one or more datasets to map and transform the one or more datasets from being in accordance with the first schema to being in accordance with the second schema.

2. The method of claim 1, wherein at least one of the one or more mappings is among the one or more identifiers and one or more second identifiers specified by the second schema.

3. The method of claim 1, wherein receiving the output includes receiving an output specifying one or more mappings and one or more transformations to be performed on the one or more datasets to transform the one or more datasets from being in accordance with the first schema and one or more first domain values to being in accordance with the second schema and one or more second domain values.

4. The method of claim 1, wherein the first schema is a source schema, and the second schema is a target schema.

5. The method of claim 1, wherein the profiling includes profiling one or more fields of the one or more datasets.

6. The method of claim 1, wherein the output is a specification.

7. The method of claim 1, further including:
transforming the output into a computational dataflow graph for processing one or more data records of the one or more datasets.

8. The method of claim 1, further including performing training of the machine learning model, by:
accessing, from a data store, a plurality of specifications;
identifying a plurality of transformations specified by the specifications;
generating a vocabulary of transformations, by:
for each transformation,
naming the transformation;
for a given transformation, identifying one or more mappings for one or more inputs and one or more outputs of the given transformation;
based on the generated vocabulary and identified mappings, generating descriptions of inputs and outputs associated with named transformations in the vocabulary of transformations, with a description describing how data is mapped and transformed from a source schema and source value domain to a target schema and target value domain;
transmitting, to a machine learning model trainer, the generated descriptions; and
training, by the machine learning model trainer, the machine learning model on the generated descriptions.

9. One or more machine-readable hardware storage devices for using a machine learning model to automatically identify mappings and transformations to map and transform datasets from a first schema to a second schema, the one or more machine-readable hardware storage devices storing instructions that are executable by one or more processing devices to perform operations including:
receiving one or more indications of one or more datasets, with the one or more datasets being structured with one or more fields, and with a first schema specifying one or more identifiers for the one or more fields;
responsive to the one or more indications, accessing the one or more datasets and metadata associated with the one or more datasets;
profiling at least a portion of the one or more datasets accessed to generate profiled data;
based on the profiled data and the metadata, identifying one or more classifications for the one or more fields;
generating one or more classification associations among the one or more identifiers and the one or more classifications, wherein a given identifier of the one or more identifiers is associated with a given classification of the one or more classifications, wherein the given identifier is associated with a given field of the one or more fields, and wherein the given classification classifies the given field associated with the given identifier;
receiving a second schema to which the datasets are to be transformed;
inputting, into a machine learning model, the profiled data, the classification associations and the second schema; and
receiving, from the machine learning model, an output specifying one or more mappings and one or more transformations to be performed on the one or more datasets to map and transform the one or more datasets from being in accordance with the first schema to being in accordance with the second schema.

10. The one or more machine-readable hardware storage devices of claim 9, wherein at least one of the one or more mappings is among the one or more identifiers and one or more second identifiers specified by the second schema.

11. The one or more machine-readable hardware storage devices of claim 9, wherein receiving the output includes receiving an output specifying one or more mappings and one or more transformations to be performed on the one or more datasets to transform the one or more datasets from being in accordance with the first schema and one or more first domain values to being in accordance with the second schema and one or more second domain values.

12. The one or more machine-readable hardware storage devices of claim 9, wherein the first schema is a source schema, and the second schema is a target schema.

13. The one or more machine-readable hardware storage devices of claim 9, wherein the profiling includes profiling one or more fields of the one or more datasets.

14. The one or more machine-readable hardware storage devices of claim 9, wherein the output is a specification.

15. The one or more machine-readable hardware storage devices of claim 9, wherein the operations further include:
transforming the output into a computational dataflow graph for processing one or more data records of the one or more datasets.

16. The one or more machine-readable hardware storage devices of claim 9, wherein the operations further include performing training of the machine learning model, by:
accessing, from a data store, a plurality of specifications;
identifying a plurality of transformations specified by the specifications;
generating a vocabulary of transformations, by:
for each transformation,
naming the transformation;
for a given transformation, identifying one or more mappings for one or more inputs and one or more outputs of the given transformation;
based on the generated vocabulary and identified mappings, generating descriptions of inputs and outputs associated with named transformations in the vocabulary of transformations, with a description describing how data is mapped and transformed from a source schema and source value domain to a target schema and target value domain;
transmitting, to a machine learning trainer, the generated descriptions; and
training, by the machine learning trainer, the machine learning model on the generated descriptions.

17. A computer-implemented method for training a machine learning model to automatically identify mappings and transformations for mapping and transforming datasets from one schema to another schema, including:
accessing, from a data store, a plurality of specifications, with a specification specifying a transformation, an input to the transformation and an output from the transformation;
for a given specification,
generating a mapping between an input to a transformation and an output from the transformation;
associating a name with the transformation; and
generating a description of the transformation, with the description specifying the name and the mapping;
transmitting, to a machine learning model trainer, generated descriptions of transformations; and
causing training, by the machine learning model trainer, of a machine learning model based on the generated descriptions to train the machine learning model to automatically identify one or more mappings among one or more inputs and one or more outputs and one or more names of transformations for transforming the one or more inputs into the one or more outputs.

18. The method of claim 17, wherein the mappings included in the generated descriptions represent mappings of first fields in a first schema to second fields in a second schema, and wherein a name specifies one or more transformations to be performed in transforming a value of a first field into a value for a second field.

19. The method of claim 17, wherein the one or more inputs are based on one or more fields of a first schema, and wherein the one or more outputs are based on one or more fields of a second schema.

20. The method of claim 17, further including:
for a given specification, augmenting the description of the transformation with metadata for the input to the transformation and the output from the transformation.
